(19) United States
(12) Patent Application Publication
(10) Pub. No.: US 2024/0034694 A1
(43) Pub. Date: Feb. 1, 2024

(54) URINE BASED NUTRIENT-RECOVERY SYSTEMS AND METHODS

(71) Applicants: Hilda Maingay, East Falmouth, MA (US); Earle Barnhart, East Falmouth, MA (US)

(72) Inventors: Earle BARNHART, East Falmouth, MA (US); Hilda MAINGAY, East Falmouth, MA (US)

(21) Appl. No.: 18/350,007

(22) Filed: Jul. 11, 2023

Related U.S. Application Data
(60) Provisional application No. 63/392,142, filed on Jul. 26, 2022.

(51) Int. Cl. C05F 17/907; C05F 17/60

(52) U.S. Cl. CPC C05F 17/907; C05F 17/60

(57) ABSTRACT

Devices, systems and methods that provide for separation of urine. The separated urine can be processed and used as a fertilizer. The urine-based fertilizer provides a lower cost, environmentally responsible, alternative to synthetic fertilizer with a guaranteed constant and locally available supply. Additionally, the devices, systems and methods reduce the use of fresh water associated with toilet flushing.

### CROSS-REFERENCE

This application claims the benefit of U.S. Provisional Application No. 63/392,142, filed Jul. 26, 2022, which application is incorporated herein in its entirety by reference.

### BACKGROUND

Nitrogen (N) is one of the most widely distributed elements in nature. Nitrogen is also necessary for many plant and animal metabolic processes. Since the Haber-Bosch process using natural gas for synthesizing N fertilizer was developed early in the 20th century, nitrogen's importance in maintaining the global food supply has rapidly grown. In fact, approximately half the food produced now in the world is supported by the use of synthetic nitrogen fertilizer. Phosphorus (P) is another mineral fertilizer essential for plant growth. Phosphorus is a non-renewable, rapidly dwindling mined resource. Both the production of nitrogen and mining of phosphorus fertilizers are extremely energy intensive, environmentally damaging and contributing to climate change. Costs for N and P fertilizers have increase over recent years but since the 2022 Russian invasion of Ukraine and the accompanying sanctions, supplies of these fertilizers have been disrupted and prices have skyrocketed.

On average an adult excretes about 120 gallons of urine per year, or about 0.33 gallons a day. Human urine is composed primarily of water (95%). Human urine also contains significant amounts of nitrogen, phosphorus, potassium, and sulfur well as micronutrients such as calcium, magnesium, zinc, copper, nickel, cadmium, and lead. The nitrogen-containing compounds in urine are: urea (2%), creatinine (0.1%), uric acid (0.03%), and ammonia. Protein is only found in trace amounts compared to protein values in blood plasma. On average a person excretes about 10 lbs of nitrogen, 1.28 lbs of phosphorus and 2.8 lbs of potassium per year. Most of the nitrogen, about 91 lbs, is in the urine. The NPK ratio of human urine is about 11:1:2.5, but varies depending on diet: the more protein in the diet, the more nitrogen in the urine. In the United States, it is estimated that Americans produce about 99 million gallons of urine per day containing about 8 million pounds of N. Urine is only 1% of the volume of the wastewater stream but contains 80% of the nitrogen in wastewater and is responsible for 80% of the cost of wastewater treatment at a sewer plant. In WWTP's CO2 and H2O are released during biological nitrogen removal processes. Wastewater treatment plants (WWTP) are contributing 3% of all global greenhouse gas (GHG) emissions, not including externalities such as the cost of wasting clean drinking water and wasting all the nutrients like nitrogen and phosphorus which have to be produced and mined to replace the wasted ones and the CO2 and N2O emissions from incinerating sewage sludge.

WWTP's are the 6th largest contributors of nitrous oxide, a GHG that is 265 times more potent than CO2. Global emissions from WWTP's are expected to grow significantly. Removing urine from wastewater treatment significantly reduces GHG emissions from WWTP's.

Nutrients in urine can become a source of pollution when the components enter the water of a watershed. In the US, for example, the nutrients in urine pass through either cesspools, septic systems or WWTP's into rivers, lakes, estuaries and oceans. Once urine enters the aquatic environment, excess nutrients (particularly nitrogen and phosphorus) can cause harmful algal blooms (HABs), depletion of oxygen and fish kills. Preventing urine from entering the waterways is the quickest and least expensive way to reduce water pollution and GHG emissions. WWTP's are the most energy-expensive entities in most towns and cities. Removing urine from entering WWTP's would greatly reduce the cost of operation and maintenance.

The United Nations has stated that access to safe water, sanitation and hygiene is the most basic human need for health and well-being. Misuse, poor management, over-extraction of groundwater, and contamination of freshwater exacerbates water stress. In addition, there are growing challenges linked to degraded water-related ecosystems, water scarcity caused by climate change, and underinvestment in water and sanitation. Failure to address these issues has already resulted in billions of people with lack of access to clean water.

On average a person needs 1-2 gallons of clean water per day for drinking and cooking or 365-730 gallons per person per year. Standard toilets use pure drinking water for flushing. It is estimated that the average person flushes the toilet about 5-8 times per day. Older toilets used 7 gallons per flush, while newer toilets are as low as 1.6 gallons per flush. On average 6000 gallons of water are used per person per year for flushing, 4000 gallons just for flushing urine alone. With an increasing clean water shortage, an instability in the global supply and increasing costs of fertilizer needed for food production, providing a mechanism for urine diversion has become an important potential solution for all these issues, while at the same time addressing the critical importance of reducing GHG emissions.

Urine is one of the largest contributors of water pollution and demise of aquatic eco-systems. On the other hand, urine is the most valuable macro-and micronutrient source for agricultural fertilizers with a guaranteed reliable, constant and local supply. Currently there are several fixtures on the market which divert urine from the waste stream, including, for example, the simple portable unisex urinals called “Cubie” produced by and available from the Rich Earth Institute (https://richearthinstitute.org/recommended-tools/), with or without a seat; urine diverting (UD) eco-toilets such as Separett® (www.separett.com), urine-only urinal toilet as well as incinerating toilets from Cinderella® (www.cincerellaeco.com), urine diverting flush toilet from Wostman® (www.wostman.se) and composting self-contained toilets such as BioLet® (www.biolet.com).

The fixtures mentioned above all remove urine from the waste stream but require some degree of behavior modification from the users. Urinals however are used by men in most public places all over the world and would not require behavior modification when installed in residential settings. Waterless urinals could immediately divert urine from the waste stream, conserve clean water, improve water quality, provide affordable nitrogen and phosphorus fertilizer, and reduce GHG emissions.

However, surveys and anecdotal evidence have concluded that homeowners do not want traditional urinals in their bathroom for any or all the following reasons a) they smell b) they cause splashes outside the device c) they protrude too much into the room d) the bathrooms are too small e) they are too expensive to buy and maintain f) they are aesthetically offensive.

What is needed are devices, methods and systems to divert urine from the waste stream and collect it in a designated storage tank, ready to be processed into fertilizer on location or at a central location and close the broken nutrient cycle.

### SUMMARY

Disclosed are devices, systems and methods for collecting human urine. Also disclosed are devices, methods and systems to divert urine from the waste stream and collect it in a designated storage tank, ready to be processed into fertilizer on location or at a central location and close the broken nutrient cycle.

The urine diversion devices are configurable to comprise: a body having a rear surface, two side surfaces, a top surface and a lower surface engaging the rear surface, an open side, and a lower side aperture positioned in the lower surface of the body wherein the body defines a cavity; a bezel positioned around an opening in the body; a cover operable to pivotally engage the body wherein the cover is positionable within a recess of the bezel when the cover is in a closed configuration; and a drain cover having a plurality of apertures operable to engage the aperture in the lower side of the body. The apertures can be round, square, oval, rectangular, or any other suitable shape.

The urine diversion systems are configurable to comprise: a urine diversion device having a body with a rear surface, two side surfaces, a top surface and a lower surface engaging the rear surface, an open side, and a lower side aperture positioned in the lower side of the body wherein the body defines a cavity, a bezel positioned around an opening in the body, a cover operable to pivotally engage the body wherein the cover is positionable within a recess of the bezel when the cover is in a closed configuration, a drain cover having a plurality of apertures operable to engage the aperture in the lower side of the body; and a storage tank in communication with the body. The apertures can be round, square, oval, rectangular, or any other suitable shape.

Methods of processing urine comprise: providing a urine diversion device comprising a body having a rear surface, two side surfaces, a top surface and a lower surface engaging the rear surface, an open side, and a lower side aperture positioned in the lower side of the body wherein the body defines a cavity, a bezel positioned around an opening in the body, a cover operable to pivotally engage the body wherein the cover is positionable within a recess of the bezel when the cover is in a closed configuration, a drain cover having a plurality of apertures operable to engage the aperture in the lower side of the body; providing a storage tank; collecting urine from the storage tank; and pasteurizing collected urine.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

NOE-HAYS, et al., Urine Diversion for Nutrient Recovery and Micropollutant Management: Results from a Regional Urine Recycling Program, Proceedings of the Water Environment Federation (WEFTEC) (19), pp. 3993-4002 (2015);

Rich Earth Institute product The Cubie, description available at https://richearthinstitute.org/recommended-tools/

Rich Earth Institute product Seated Pee Toilet, description available at https://richearthinstitute.org/recommended-tools/

US 2013/0053729 A1 published Feb. 28, 2013 to Stevic-Wages et al.;

U.S. Pat. No. 5,409,473 A issued Apr. 25, 1995 to Rosenshein;

U.S. Pat. No. 10,512,947 B2 issued Dec. 24, 2019 to Ho;

U.S. Pat. No. 11,236,497 B2 issued Feb. 1, 2022 to Morfin;

U.S. Pat. No. 11,208,799 B2 issued Dec. 28, 2021 to El-Taher; and

WO 2016/005734 A1 published Jan. 14, 2016 Stewart.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a wall-mounted urine diversion device in an exemplar environment;

FIGS. 2A-2D illustrate views of a wall-mounted urine diversion device; FIG. 2A illustrates a planar front view of the wall-mounted urine diversion device with a closed front panel, FIG. 2B illustrates a planar front view of the wall-mounted urine diversion devices with an open front panel; FIG. 2C illustrates a side view of the wall-mounted urine diversion device with the front panel open; FIG. 2D illustrates a perspective view of the wall-mounted urine diversion device with the front panel open;

FIGS. 3A-3F illustrate the urine diversion device from various views;

FIGS. 4A-4F illustrate the cover of the wall-mounted urine diversion device from front, back, side, top and perspective views; FIG. 4F illustrates a close-up of a latching mechanism;

FIGS. 5A-5E illustrate a bezel for the urine diversion device from front, side, back and perspective views;

FIGS. 6A-6E illustrate the body of the urine diversion device connected to a lower tubular member from front, side, top, back and perspective views;

FIGS. 7A-7H illustrate the body top of the urine diversion device;

FIGS. 8A-C illustrate the drain cover of the urine diversion device from front, side and perspective views; and

FIG. 9 illustrates a side view of an installed urine diversion system.

### DETAILED DESCRIPTION

### I. Devices

A urine diversion device 100 is disclosed. The urine diversion device 100 comprises: a body 230 having a rear surface 612, two side surfaces 610,614, a top surface and a lower surface 616 engaging the rear surface 612, an open side, and a lower side aperture positioned in the lower surface 616 of the body 230 wherein the body 230 defines a cavity 214; a bezel 250 positioned around an opening in the body 230; a cover 250 operable to pivotally engage the body 230 wherein the cover 250 is positionable within a recess of the bezel 250 when the cover 250 is in a closed configuration; and a drain cover 280 having a plurality of drain cover apertures 820 operable to engage the body aperture 652 in the lower side of the body. The drain cover apertures 820 can be round, square, oval, rectangular, or any other suitable shape. The cavity 214 is defined by the walls and exterior surfaces and has a center. The body 230 can be formed from two pieces, an upper piece and a lower piece.

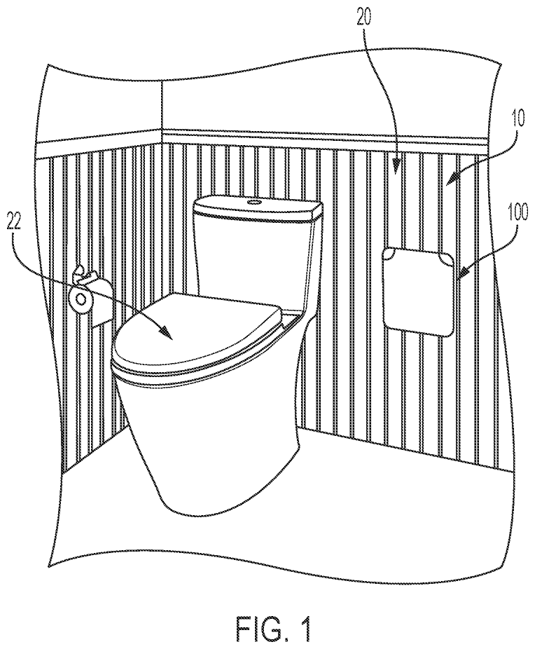

Turning to FIG. 1, a urine diversion device 100 is shown mounted on a wall 10 in in an exemplar environment 20, such as a bathroom having a toilet 22. As will be appreciated by those skilled in the art, the environment 20 can have other features, such as sinks, minors, showers, tubs, etc. In this figure, the urine diversion device 100 is shown mounted to a wall 10 positioned vertically adjacent the toilet 22.

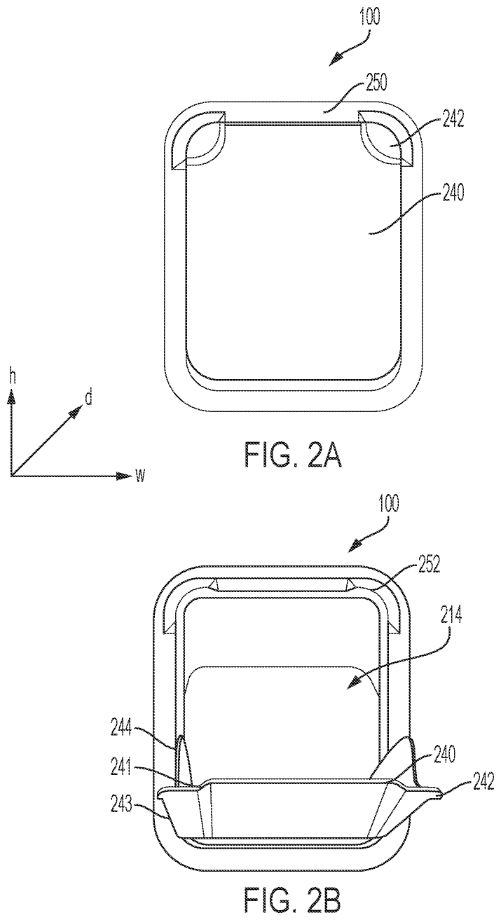

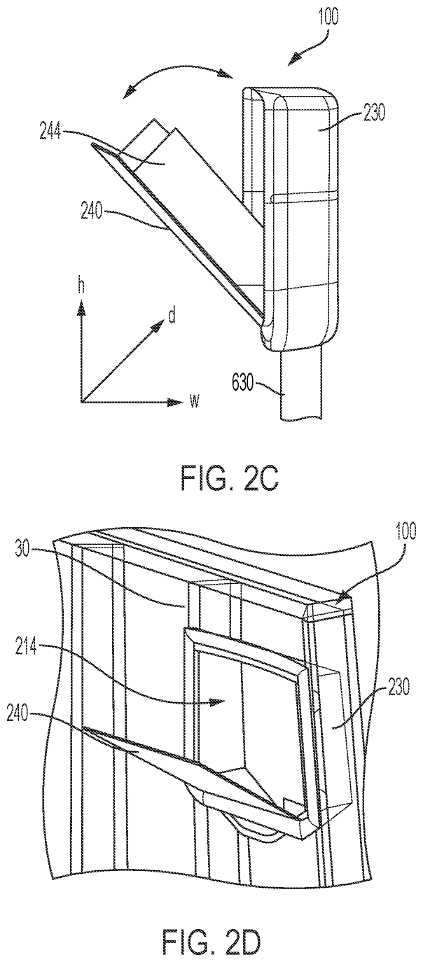

FIGS. 2A-2D illustrate views of a urine diversion device 100. The urine diversion device 100 has a height (h) width (w) and depth (d). Turning to FIG. 2A, the urine diversion device 100 is shown from a front planar perspective (e.g., height and width) with a closed cover 240 or front panel. The urine diversion device 100 can have a square height and width two-dimensional shape when taken from a planar front view with rounded edges as shown. Other height and width shapes, such as round, square (90 degree edges), oval, ovoid, triangular (rounded or sharp edges) and rectangular (rounded or sharp edges) can be used without departing from the scope of the disclosure. The cover 240 of the urine diversion device 100 can have one or more raised edge 242. The one or more raised edge 242 is operable to allow a user to pull the cover 240 forward (i.e., towards a user) into an open position (shown in FIG. 2C). Additionally, or in the alternative, the bezel 250 can have one or more bezel recesses 252 that are operable to allow the user to pull the cover 240 into an open position away from the wall. The exterior shape of the bezel 250 or frame member can be selected to surround the opening of the body 230. In the closed position, the cover 240 is positioned flush against the bezel 250.

FIG. 2B illustrates a planar front view of the urine diversion device 100 with the cover 240 in an open position. The front cover 240 is shown extended away from the wall (when installed) to provide access an internal cavity of the urine diversion device 100. When the body 230 and the front cover 240 are connected and in a closed configuration, an interior cavity 214 is defined.

FIG. 2C illustrates a side view of the urine diversion device 100 with the front cover 240 extended away from the wall and the bezel 250. From the view in FIG. 2C the height and depth of the urine diversion device 100 is shown. As will be appreciated from these views, the height and width are greater than the depth of the urine diversion device 100. A side wall 244 extends from the internal surface of the cover 240. The side wall 244 extends from the internal surface 241 of the cover 240 at a location that is positioned away from the outer edge 243 of the cover 240.

FIG. 2D also illustrates a perspective view of the urine diversion device 100 with the cover 240 extended into an open configuration as installed without the wallboard. The perspective view of the urine diversion device 100 in FIG. 2D shows the height, width and depth and also shows the surrounding wall studs 30 prior to application of drywall.

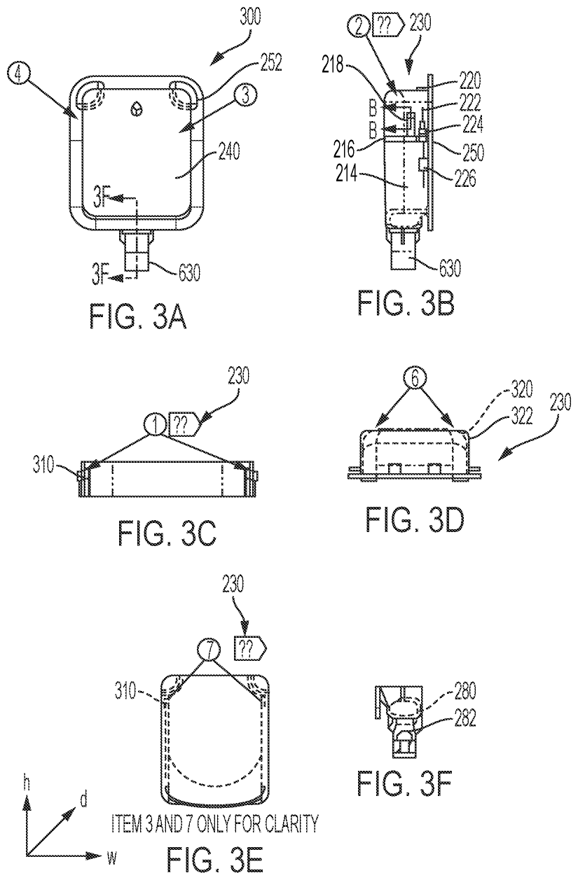

FIGS. 3A-3F illustrate the body 230 of the urine diversion device 100. The body 230 has a height, width, and depth. Turning to FIG. 3A a front view of the body 230 is shown with the bezel 250 around the edge of the body 230. The one or more bezel recesses 252 of the bezel is accessible by the user when the cover 240 is in a closed position. The one or more bezel recesses 252 allow the user to position a finger between the cover and the body to pull the cover forward and into an open position.

FIG. 3B is a side view of the body 230 showing the body in communication with a tubular member 630 such as a urine diversion pipe. The interior cavity 214 can have a seam 216 between an upper portion of the body 230 and a lower portion of the body 230. A slot 218 is provided that is operable to receive a magnet associated with the body 230. A snap clip 254 is provided that is operable to attach the bezel 250. A shallow bar 222 on the body 230 is provided to accept a snap clip of the bezel. A top tab 224 is provided for secure alignment of the bezel 250 when attached. A bottom tab 226 on the side of the bezel for secure alignment of the bezel 250 when attached.

FIG. 3C shows a top view of the body 230 which includes one or more magnets 310 which are operable to mate with one or more magnets on the cover when the cover and body are in close proximity. The one or more magnets 310 are operable to assist in keeping the cover 240 in a closed position against the body 230 when the urine diversion device 100 is not in use. From the view in FIG. 3D, a lip 320 extends away from the body 230. The lip 320 has one or more lip apertures 322 that are sized and operable to receive a fastener through the one or more lip apertures 322. The lip apertures 322 can be used to secure the urine diversion device to, for example, a wall stud. FIG. 3E illustrates the body 230 from the rear surface showing magnets 310. FIG. 3F is a cross-section of a portion of the body 230 taken along the lines 3F-3F in FIG. 3A. The view in FIG. 3F illustrates the drain cover 280 and a curtain valve 282. As will be appreciated by those skilled in the art, a curtain valve is a simple variable-geometry device that controls the opening and closing of the specified window, or valve curtain area, determined by a camshaft and rocker ratio.

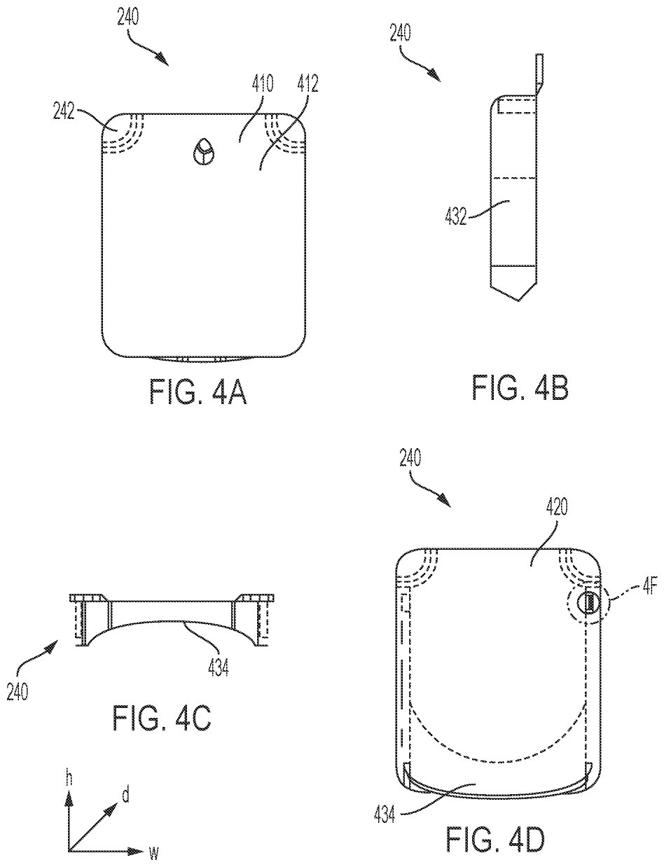

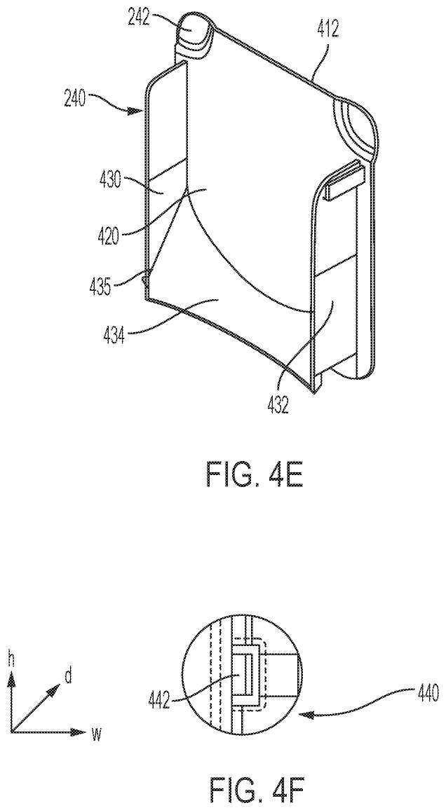

FIGS. 4A-4F illustrate the cover 240 of the urine diversion device 100. As shown in FIG. 4A, the cover 240 has a front member 410 with a substantially flat exterior facing surface 412. The exterior facing surface 412 can be flat, substantially flat, convex or concave without departing from the scope of the disclosure. The front member 410 can, as noted above, have one or more raised edges 242. The raised edge 242 can be raised relative to the exterior facing surface 412. The interior facing surface 420 has three walls 430, 432, 434 that extend from the interior facing surface 420. As illustrated, two of the three walls, e.g., first wall 430 and second wall 432 can be parallel to one another and be positioned toward an exterior edge of the cover 240. A third wall 434 or lower wall can be positioned such that at a first edge 435 of the third wall 434 engages the first wall 430 and the second edge of the third wall engages the second wall 432. Positioning of the third wall 434 to the first wall 430 and the second wall 432 can be oriented such that the third wall 434 is not perpendicular to the interior facing surface 420. Additionally, alternative configurations of the first wall 430, second wall 432, and third wall 434 can be used without departing from the scope of the disclosure. For example, instead of three walls, two walls that meet in a “V” at a lower end, or a single u-shaped wall could be used. Moreover, where a single wall is used, a portion of the wall could be parallel to the interior facing surface 420 while another portion extends at an angle from the interior facing surface wherein the angle is not 90°. In at least some configurations, the cover wall or walls can be formed integrally with the interior facing surface such that the entire three-dimensional structure is formed from one piece of material or can be formed from component parts secured together. The width of the cover 240 ranges from 7″ to 24″ (more preferably 9″), the height ranges from 10″ to 30″ (more preferably 11″), and the depth ranges from 3″ to 5″ (more preferably 2.3″). The thickness of the walls forming, for example, the cover and the walls is about 0.2″. The cover 240 is operable to rotate away from the wall from 30 degrees to 60 degrees, more preferably 48 degrees.

FIG. 4B is a side view of the cover 240 illustrating the side walls 430, 432 have a height less than the overall height of the front member 410. From the side view, it is apparent that the walls of the cover 240 have a height less than the overall height of the cover.

FIG. 4C is a top view of the cover 240 showing a depth and width of the cover 240. From the view in FIG. 4C the third wall 434 has a curved profile such that the curve is convex towards the interior facing surface 414 of the cover 240.

FIG. 4D is an interior planar surface view of the cover 240. The interior facing surface 420 faces inward towards the cavity created by the device when the cover 240 engages the body 230. The first wall 430, second wall 432, and third wall 434 extend from interior facing surface 420 at a location recessed from the edge of the cover 250. FIG. 4E is a perspective view of the cover 240 from the interior facing surface 420. The third wall 434 is shown with a curved profile extending from the interior facing surface 420 such that the entire length of the third wall 434 extends from different vertical positions on the interior facing surface 420. FIG. 4F is a close view of a portion of the latching mechanism 440 shown in FIG. 4D. The latching mechanism 440 can include a magnet 442 embedded in the cover 240. The position of the magnet 442 corresponds to a position of a magnet in the body so that when the cover is brought into a closed configuration, the attractive forces of the magnet will hold the cover in the closed position against the body.

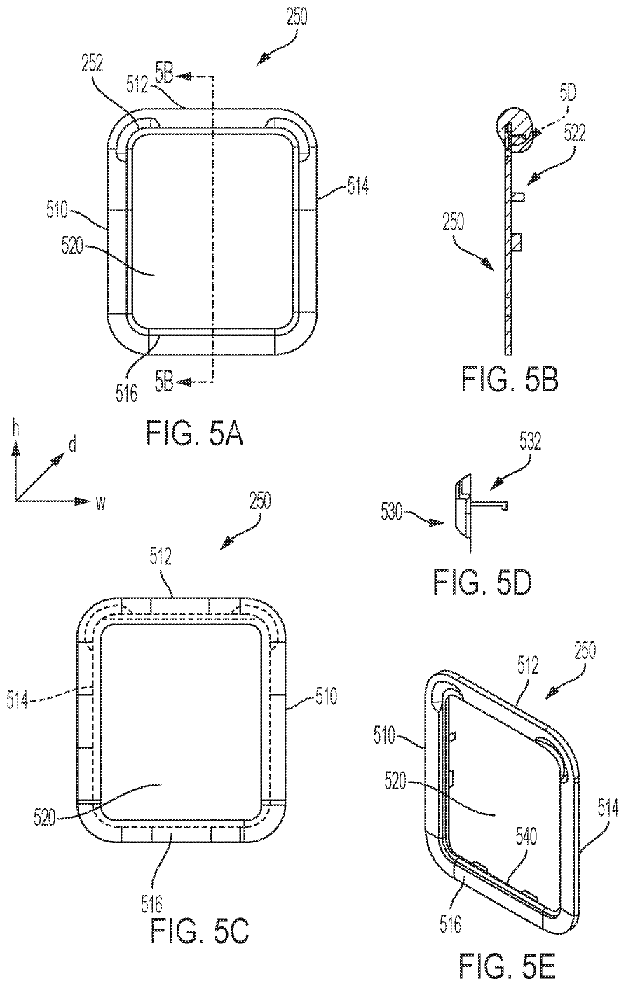

FIGS. 5A-5E illustrate a bezel 250 of the urine diversion device 100. FIG. 5A is a planar front exterior view of the bezel 250. The bezel 250 has four side members 510, 512, 514, 516 which define an opening 520. As described previously, one or more bezel recesses 252 can be provided to facilitate pulling the cover 250 away from the body of the urine diversion device 100 during use. Each of the four side members 510, 512, 514, 516 has a width. Additionally the overall bezel 250 has a length, height, and width. FIG. is a cross-sectional side view of the bezel 250 taken along the lines 5B-5B. One or more alignment members 522 or surfaces can be provided that are raised from the rear surface of the bezel 250. The alignment members extend from the rear surface to engage a recess or aperture in the body.

FIG. 5C is a rear view of the bezel 250. The width of the bezel 250 ranges from 7″ to 24″ (more preferably 11″), the height ranges from 10″ to 30″ (more preferably 13″), and the bezel opening 520 height ranges from 7″ to 26″ (more preferably 10″) and the width ranges from 5″ to 12″ (more preferably 8.6″). The thickness of the walls forming, for example, the cover and the walls is about 0.2″.

FIG. 5D is an close-up view of the locking mechanism 530 from the side view shown in FIG. 5B. An internally facing flexible detent 532 can be provided on the interior facing surface of the bezel 250. Additional The flexible detent 532 is operable to engage a recess on the body, so that the flexible detent 532 secures the bezel 250 to the body 230.

FIG. 5E is a perspective front view of the bezel 250 showing a recessed inner lip 540 or ledge surrounding the opening 520.

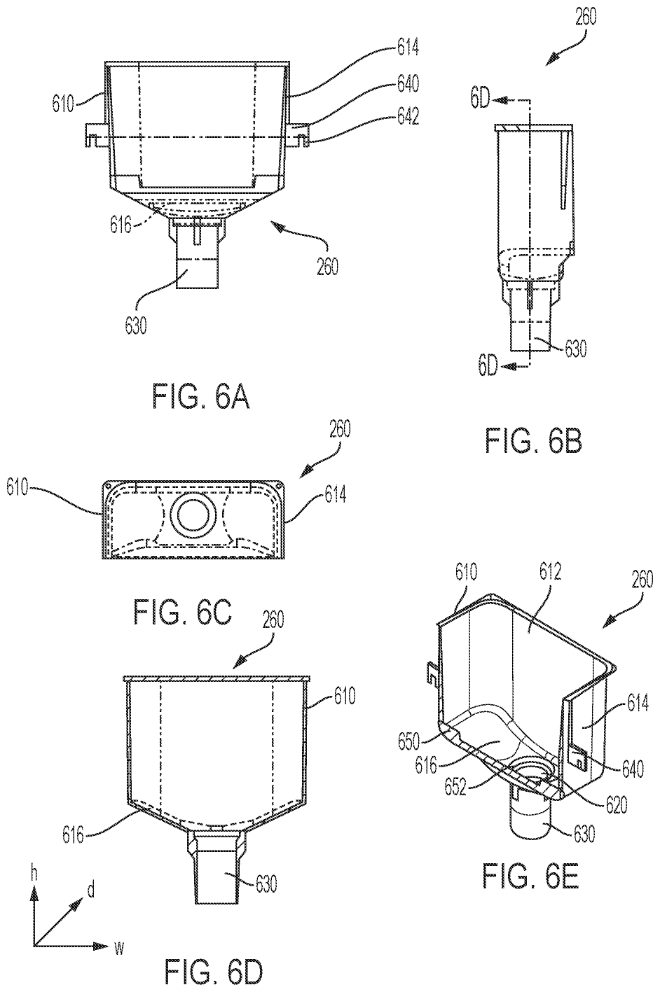

FIGS. 6A-6E illustrate the body 260 of the urine diversion device 100 connected to a lower tubular member 630. In FIG. 6A, the body 260 has a height and width. The body 260 has three vertical walls 610, 612, 614 and a curved bottom wall 616. The curved bottom wall 616 is operable to allow fluid to flow gravitationally towards an opening 620. The opening 620 is in fluid communication with a tubular member 630. One or more flanges 640 can extend from an exterior surface of the body 260. The one or more flanges 640. The flange 640 can be positioned to extend perpendicularly from the side of the body 260. The flange 640 can additionally include a notch 642. The notch 642 can be formed so that the notch slides over the head of a fastener secured to a stud wall thus allowing the body of the urine diversion device 100 to be easily removed.

FIG. 6B is a side view of the body 260 while FIG. 6C is a top view of the body 260 and FIG. 6D is a rear view of the body 260. FIG. 6E is a perspective front view of the body 260. As shown in FIG. 6E, the front face of the body 260 can have a lip 650 with a recess 652 along the length of the lip 650. The width of the body 260 ranges from 7″ to 24″ (more preferably 11″), the height ranges from 10″ to 30″ (more preferably 13″), and the depth ranges from 2″ to 6″ (more preferably 4″). The thickness of the walls forming, for example, the walls is about 0.2″. The lower surface of the body (curved bottom wall) curves from 20 degrees to 30 degrees (more preferably 26 degrees) from the side wall to the tubular member 630.

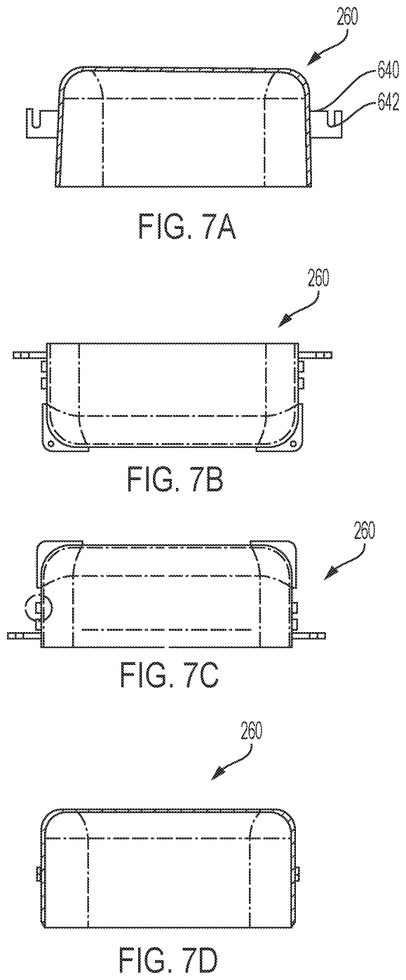

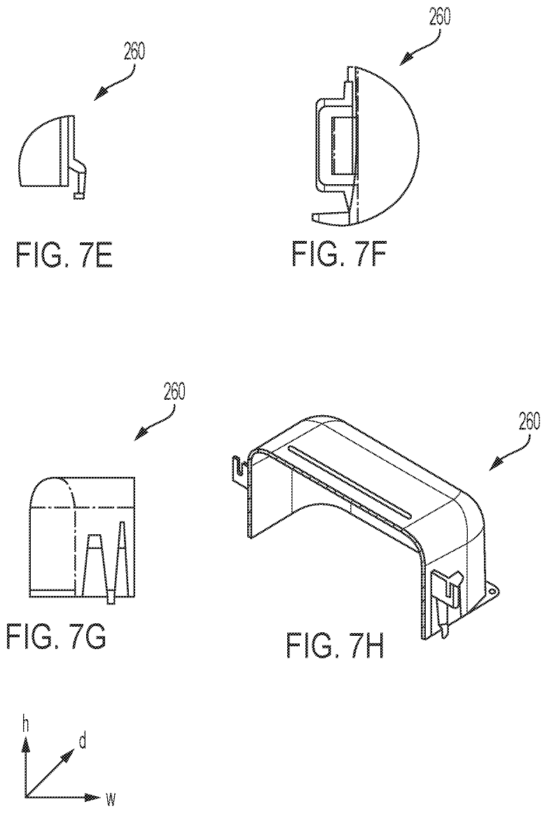

FIGS. 7A-7H illustrate additional view of a first half of the body 260 of the urine diversion device 100 where the body 260 has two a two-piece construction.

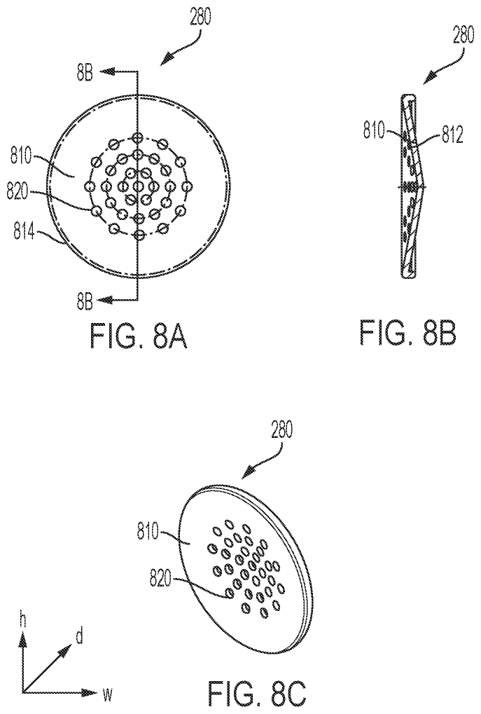

FIGS. 8A-C illustrate a drain cover 280 of the urine diversion device 100. The drain cover 280 can have a circular shape in a first dimension and an outward facing surface 810 and an opposing inward facing surface 812. The outward shape has an exterior edge 814. A plurality of apertures 820 is provided in the drain cover 280 to allow fluid material to pass into the tubular member 630.

### II. Systems

A urine diversion system is disclosed. The urine diversion system is configurable to comprise: a urine diversion device having a body with a rear surface, two side surfaces, a top surface and a lower surface engaging the rear surface, an open side, and a lower side aperture positioned in the lower side of the body wherein the body defines a cavity, a bezel positioned around an opening in the body, a cover operable to pivotally engage the body wherein the cover is positionable within a recess of the bezel when the cover is in a closed configuration, a drain cover having a plurality of apertures operable to engage the aperture in the lower side of the body; and a storage tank in communication with the body.

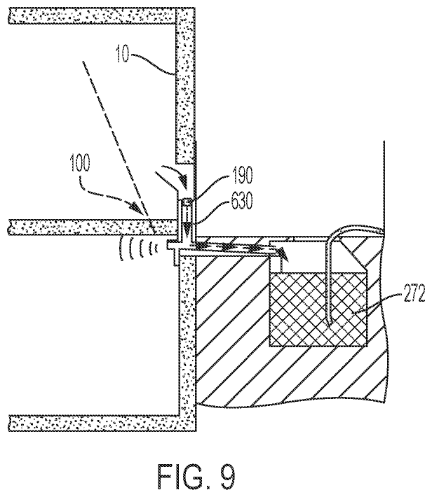

FIG. 9 illustrates a side view of an installed urine diversion device 100. The urine diversion device 100 is shown installed in a wall 10 with a tubular member 630 diverting urine collected via the wall-mounted urine diversion device 100 to a storage tank 272. A valve 290 is positioned between the urine diversion device 100 and the storage tank 272 that prevents fumes or gases from passes from the storage tank 272 to the urine diversion device 100 and back into the room. The storage tank 272 can be positioned in any convenient location that provides access for removing the stored urine where the storage tank 272 is in fluid communication with the urine diversion device 100. Potential locations include, but are not limited to a closet, a basement, an external housing, a shed or in-ground vessel. The storage tank 272 can be installed so that the storage tank 272 can be replaced when full and/or pumped when full.

The storage unit can further include a volume detector. The volume detector can be configured to be in communication with one or more alerting devices. The volume detector is operation to provide an indication of the volume. The alerting device can be configured to issue an alert when the storage tank 272 reaches a target volume. For example, the alerting device an alert when the storage tank 272 reaches 75% of capacity. Alternatively, the alerting device can be configured to issue a first alert when the volume reaches a first target volume and a second alert when the storage tank reaches a second target volume, greater than the first target volume. For example, a first alert can be issued when the storage tank 272 reaches 75% of capacity and a second alert can be issued when the storage tank reaches 95% of capacity.

The alerting device can be a light, a speaker or both. The light can be one or more lights. Alternatively, the light and/or speaker can be associated with a mobile device in wireless communication with the volume detector. For example, a light can pulse corresponding to a detected volume with a slow pulse reflecting a detected volume at 75% and a faster pulse reflecting a detected volume at 95%. Alternatively, the light can be configured to change from green to yellow to red to provide feedback about the volume of the storage tank. Alternatively, separate light indicators can be provided which are configured to illuminate in one or more colors. For example, green can be used to indicate that the tank volume is within range; yellow indicates that the volume of the tank needs attention; red indicates that the volume of the tank is near capacity.

Audible alarms can also be emitted if, for example, the volume detected exceeds an upper limit. The alarm (audible and/or visible) is provided to alert the monitoring user of the need to service the storage unit by emptying out the contents. Additionally, the volume detector may include or be configured to be operable with Bluetooth/Wi-Fi/cellular connectivity to remotely alert a user of a detected volume. Audible warnings can include, but are not limited to, a pulsatory audible tone, and a verbal alert.

A communication interface can also be provided which allows the volume detector to communicate with a second device (such as a phone) or directly to a central station. Communicating directly with a central station facilitates arranging for pick-up of current urine content.

### III. Methods

Method of processing urine are disclosed. The methods comprise: providing a urine diversion device comprising a body having a rear surface, two side surfaces, a top surface and a lower surface engaging the rear surface, an open side, and a lower side aperture positioned in the lower side of the body wherein the body defines a cavity, a bezel positioned around an opening in the body, a cover operable to pivotally engage the body wherein the cover is positionable within a recess of the bezel when the cover is in a closed configuration, a drain cover having a plurality of apertures operable to engage the aperture in the lower side of the body; providing a storage tank; collecting urine from the storage tank; and pasteurizing collected urine.

Urine diversion devices are deployed. One or more users uses the urine diversion device to separate urine from other materials, such as feces. The urine is collected in a storage tank or passed into a dedicated urine plumbing line, similar to the purple pipe system used to provide recycled water for industrial landscape. Processing the urine for further treatment can occur at the storage tank, in a secondary treatment tank or at a central location. Commonly urine is collected and transported in a designated urine tank by a licensed hauler to a central facility for storage and pasteurization. Sanitation can be accomplished through either storage (68° F./20° C. or higher for six months)on site or in a central location or pasteurization (176° F./80° C. degrees for 1.5 minutes (US EPA method). Thereafter, the processed urine can be used as fertilizer. Pasteurization renders the urine as an EPA Class A material, a fertilizer that can be used unrestricted on all crops. Further processing can occur which results in the urine being more concentrated and/or diluting the urine to achieve optimal levels of N and P. Most commonly, urine is diluted to 3-10 parts of water for plants in a growth stage, but ratios can be increased or decreased depending on intended use. Hay farmers have reported that one application of undiluted urine produced twice the amount of hay.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that any claims presented define the scope of the invention and that methods and structures within the scope of these claims and their equivalents be covered thereby.

What is claimed:

1. A urine diversion device comprising:
a body having a rear surface, two side surfaces, a top surface and a lower surface engaging the rear surface, an open side, and a lower side aperture positioned in the lower surface of the body wherein the body defines a cavity;
a bezel positioned around an opening in the body;
a cover operable to pivotally engage the body wherein the cover is positionable within a recess of the bezel when the cover is in a closed configuration; and
a drain cover having a plurality of apertures operable to engage the aperture in the lower side of the body.

2. The urine diversion device of claim 1 wherein the lower side of the body curves away from a center of the cavity.

3. The urine diversion device of claim 1 wherein the bezel has one or more recesses on an exterior surface.

4. The urine diversion device of claim 1 wherein the cover has one or more raised edges.

5. The urine diversion device of claim 1 wherein the urine diversion device is in fluid communication with a tubular member via the lower side aperture.

6. The urine diversion device of claim 5 wherein the urine diversion device is in fluid communication with a storage tank.

7. The urine diversion device of claim 6 further comprising a valve positioned between the urine diversion device and the storage tank.

8. The urine diversion device of claim 1 wherein the body and the cover have magnets.

9. The urine diversion device of claim 1 further comprising at least one of a volume indicator light and speaker.

10. The urine diversion device of claim 9 further comprising a communication interface operable to communicate a volume.

11. A urine diversion system comprising:
a urine diversion device having
a body with a rear surface, two side surfaces, a top surface and a lower surface engaging the rear surface, an open side, and a lower side aperture positioned in the lower side of the body wherein the body defines a cavity,
a bezel positioned around an opening in the body,
a cover operable to pivotally engage the body wherein the cover is positionable within a recess of the bezel when the cover is in a closed configuration,
a drain cover having a plurality of apertures operable to engage the aperture in the lower side of the body; and
a storage tank in communication with the body.

12. The urine diversion system of claim 11 wherein the lower side of the body curves away from a center of the cavity.

13. The urine diversion system of claim 11 wherein the bezel has one or more recesses on an exterior surface.

14. The urine diversion system of claim 11 wherein the cover has one or more raised edges.

15. The urine diversion system of claim 11 wherein the urine diversion device is in fluid communication with a tubular member via the lower side aperture.

16. The urine diversion system of claim 15 further comprising a valve positioned between the urine diversion device and the storage tank.

17. The urine diversion system of claim 11 wherein the body and the cover have magnets.

18. The urine diversion system of claim 11 further comprising at least one of a volume indicator light and speaker.

19. The urine diversion system of claim 18 further comprising a communication interface operable to communicate a volume.

20. A method of processing urine comprising:
providing a urine diversion device comprising a body having a rear surface, two side surfaces, a top surface and a lower surface engaging the rear surface, an open side, and a lower side aperture positioned in the lower side of the body wherein the body defines a cavity, a bezel positioned around an opening in the body, a cover operable to pivotally engage the body wherein the cover is positionable within a recess of the bezel when the cover is in a closed configuration, a drain cover having a plurality of apertures operable to engage the aperture in the lower side of the body;
providing a storage tank;
collecting urine from the storage tank; and
pasteurizing collected urine.

21. The method of claim 20 further comprising the step of communicating a volume of the storage tank.

22. The method of claim 21 further comprising the step of communicating the volume of the storage tank to a central location.

23. The method of claim 20 further comprising the step of issuing at least one of an audible and visual alarm.
